(19) United States
(12) Patent Application Publication
(10) Pub. No.: US 2024/0255035 A1
(43) Pub. Date: Aug. 1, 2024

(54) BRAKE ASSEMBLY, INCLUDING A BRAKE, AN ADAPTER, AND A TRANSMISSION

(71) Applicant: SEW-EURODRIVE GMBH & CO. KG, Bruchsal (DE)

(72) Inventor: Gao QIONGHUA, Tianjin (CN)

(73) Assignee: SEW-EURODRIVE GMBH & CO. KG, Bruchsal (DE)

(21) Appl. No.: 18/560,519

(22) PCT Filed: Apr. 19, 2022
(86) PCT No.: PCT/EP2022/025155

§ 371 Date: Nov. 13, 2023

(30) Foreign Application Priority Data
May 12, 2021 (CN) 202110517160.3
Jan. 12, 2022 (DE) 10 2022 000 114.4

(51) Int. Cl. F16D 63/00; B61C 3/00; B62B 5/00; F16D 55/00; F16D 55/02; F16D 65/00; F16D 65/18; F16D 121/22

(52) U.S. Cl. CPC F16D 63/002; B61C 3/00; B62B 5/0043; F16D 55/02; F16D 65/0081; F16D 65/18; F16D 2055/0033; F16D 2121/22

(57) ABSTRACT

A brake assembly includes a brake, an adapter, and a transmission. The adapter has an adapter housing, which is connected to a housing part of the transmission, and a flange part of the brake is connected to the adapter housing on the side of the adapter housing facing away from the transmission. A cover part of the brake is connected to the flange part, and at least one bearing for rotatably mounting the input shaft of the transmission is accommodated in the adapter housing.

### FIELD OF THE INVENTION

The present invention relates to a brake assembly, including, for example, a brake, an adapter, and a transmission.

### BACKGROUND INFORMATION

In certain conventional systems, a brake transmits a braking torque to a shaft.

### SUMMARY

Example embodiments of the present invention provide a brake assembly that is as compact as possible.

According to example embodiments of the present invention, a brake assembly includes a brake, an adapter, and a transmission. The adapter has an adapter housing connected to a housing part of the transmission. A flange part of the brake is connected to the adapter housing on the side of the adapter housing facing away from the transmission, and a cover part of the brake is connected to the flange part. At least one bearing for rotatably mounting the input shaft of the transmission is accommodated in the adapter housing.

Thus, a brake is attached to a transmission via an adapter, and the braking torque is increased by the transmission.

According to example embodiments, a first toothed part is rotationally fixed to the input shaft of the transmission, and the first toothed part is in engagement with another toothed part of the transmission. Thus, the shaft braked by the brake acts directly as the input shaft of the transmission.

According to example embodiments, the cover part together with the flange part is arranged as a housing for the brake and/or is housing-forming and/or forms the housing. Thus, the brake can be attached to the transmission in a protected manner.

According to example embodiments, a tappet is rotationally fixed to the shaft, a brake pad carrier is rotationally fixed to the tappet and is axially movable relative to the magnet body, e.g., movable back and forth, a magnetic body of the brake is rotationally fixed to the flange part, an energizable coil is accommodated in the magnet body, and an armature disk is arranged axially between the brake pad carrier and the magnet body, e.g., being movable back and forth. The armature disk is rotationally fixed to the magnet body and is arranged to be axially movable relative to the magnet body, e.g., by bolts projecting through cutouts in the armature disk and fixed to the magnet body, and spring elements supported on the magnet body press onto the armature disk. Thus, the brake engages in the event of a power failure, and an increased level of safety can be achieved. When the brake is energized, the magnetic force generated by the coil with the magnetic body overcomes the spring force generated by the spring elements in terms of magnitude, and the armature disk is pulled towards the magnetic body so that the brake is released.

According to example embodiments, a braking surface is formed on the flange part, e.g., formed in a finely machined manner. Thus, the frictional heat of the brake is transferred to a housing part.

According to example embodiments, the shaft projects through the magnet body. Thus, an angle sensor is connectable and/or arrangeable inside the cover part on the end region of the shaft facing away from the adapter housing.

According to example embodiments, the brake is connected directly to the transmission via the adapter, e.g., no motor or electric motor is interposed. Thus, the brake can be arranged to be very small, because the transmission translates the braking torque into a larger braking torque.

According to example embodiments, a terminal box is attached to the outside of the cover part, to which the supply lines of the brake, e.g., the coil, are led out. Thus, a terminal of the brake is readily accessible and implementable.

According to example embodiments, the bearing accommodated in the adapter housing centers, in relation to each other, two parts of the adapter housing forming the adapter housing, and one of the parts is connected to the flange part having one or the braking surface of the brake. Thus, the centering acts via the bearing and therefore also relative to the shaft.

According to example embodiments, the adapter housing has a cuboidal region. Thus, high torsional stiffness can be achieved. Thus, a high braking torque is recoverable.

According to example embodiments of the present invention, in a storage and retrieval device including a brake assembly, a wheel, arranged as a lateral guide, e.g., a guide wheel, is rotationally fixed to the output shaft of the transmission.

Thus, no separate wheel axle is required, but rather the output shaft of the transmission is directly connectable to the wheel in a rotationally fixed manner.

According to example embodiments, the wheel is arranged on the top side of a frame of the storage and retrieval device. Thus, a braking torque can be applied to both the drive, which is arranged on the bottom side and has a further brake, and a guide wheel, which is arranged on the top side.

According to example embodiments, a drive wheel driven by an electric drive is arranged on the bottom side of the frame of the storage and retrieval device, and, for example, the drive wheel is arranged as a rail wheel. Thus, the driving is done close to the ground. The drive is also equipped with a further brake so that braking can be performed instead of acceleration.

Further features and aspects of example embodiments of the present invention are explained in more detail below with reference to the appended schematic Figures.

### BRIEF DESCRIPTION OF THE DRAWINGS

FIG. 1 is a top view of a storage and retrieval device that has a brake assembly 4.

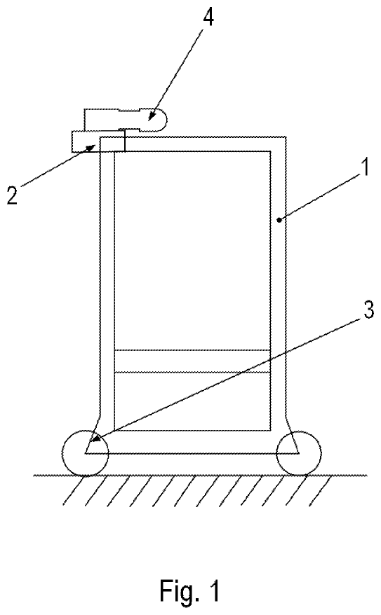

FIG. 2 is a side view of the storage and retrieval device.

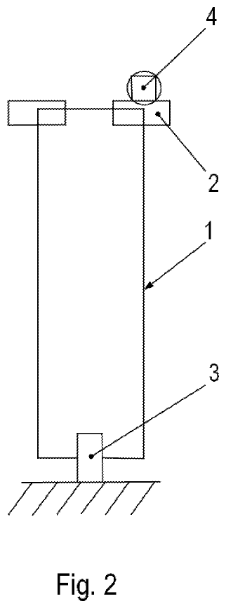

FIG. 3 is a perspective view of the brake assembly.

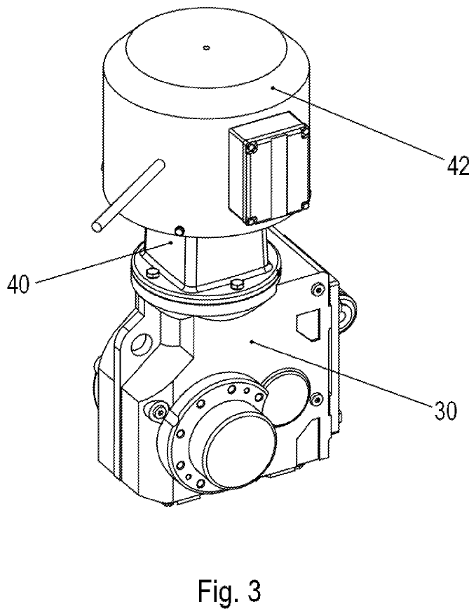

FIG. 4 is a cross-sectional view through an area of the brake assembly 4.

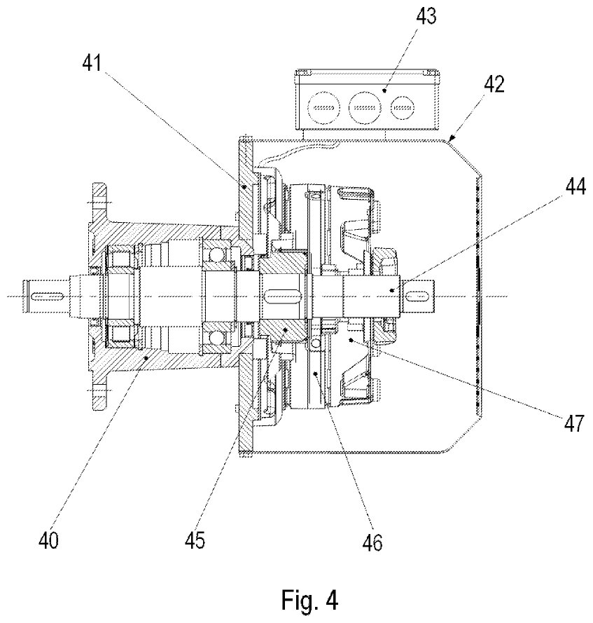

### DETAILED DESCRIPTION

As illustrated in the Figures, a drive wheel 3 is arranged on the frame 1 of the storage and retrieval device on the bottom side, and a wheel 2, which is brakable by the brake assembly, is arranged on the top side of the storage and retrieval device.

For example, the drive wheel 3 is arranged as a rail wheel and rolls on a rail arranged on the floor of the system that includes the storage and retrieval device.

For lateral guidance, wheels 2 are arranged on the top side of the frame 1, in which at least one of the wheels 2 is brakable by the brake assembly.

For this purpose, this wheel 2 is rotationally fixed to an output shaft of a transmission 30 of the brake assembly 4. For example, the wheel 2 is plugged onto the output shaft and rotationally fixed, e.g., by a key connection.

The input shaft 44 of the transmission has a smaller diameter than the output shaft of the transmission because a smaller torque is applied to the input shaft 44.

The transmission 30 is arranged as an angular gear so that the input shaft 44 is aligned perpendicular to the output shaft.

Instead of an electric motor driving the transmission 30, an electromagnetically actuable brake is provided, which is connected to the transmission 30 via an adapter.

For this purpose, the adapter has an adapter housing 40 that is connected to a housing part, e.g., a flange, of the transmission 30, e.g., using screws. On the side of the adapter housing 40 facing away from the transmission 30, a flange part 41 is connected to the adapter housing 40.

The adapter housing 40 is arranged in two parts and accommodates a bearing for rotatably mounting the shaft 44. The bearing is accommodated in both the first and second parts of the adapter housing 40, thus centering the two parts relative to each other. The flange part 41 is connected to one of the two parts.

The brake is surrounded by a cover 42, which is connected to the flange part 41 and thus is arranged as a housing for the brake. A terminal box 43 is attached to the outside of the cover 42, to which terminal box 43 the electrical supply lines of a coil of the brake are led out.

The coil can thus be energized.

The brake has a magnet body 47 made of ferromagnetic material, which is rotationally fixed to the flange part 41.

An annular recess is formed in the magnet body 47, in which the coil formed as an annular coil is accommodated.

The shaft 44 projects through the magnet body 47.

A ferromagnetically arranged armature disk 46 is arranged between the magnet body 47 and the flange part 41, which armature disk 46 is rotationally fixed to the magnet body 47 but is axially movable back and forth, i.e., parallel to the direction of the axis of rotation of the shaft 44.

Spring elements supported on the magnet body 47 press on the armature disk 46. Thus, the armature disk 46 is pulled toward the magnet body 47 against the spring force generated by the spring elements.

An annular tappet 45 is rotationally fixed to the shaft 44, e.g., by a key connection. The tappet 45 has an external toothing. A disc-shaped brake pad carrier is plugged onto the tappet 45 and has an internal toothing that engages with the external toothing.

Thus, the brake pad carrier is rotationally fixed to the shaft 44, but is axially movable back and forth. The brake pad carrier is arranged between the flange part 41 and the armature disk 46 and, for example, has brake pads axially on both sides.

If the coil is not energized, the spring elements press the armature disk 46 onto the brake pad carrier, which is thus towards the flange part 41, e.g., onto a finely machined surface of the flange part 41 acting as a braking surface. Thus, the brake engages, generates a braking torque, and allows the transmission 30 to amplify this braking torque in accordance with the gear ratio of the transmission 30 toward the output shaft.

For example, the storage and retrieval device is arranged as a rail vehicle.

According to example embodiments, the transmission 30 is arranged as a spur gear, i.e., for example, as a parallel shaft gear.

According to example embodiments, an angle sensor is arrangeable on the end region of the shaft 44 for capturing the angular position of the shaft 44, the end region projecting from the magnet body 47.

### LIST OF REFERENCE NUMERALS

1 Frame of the storage and retrieval device
2 Wheel
3 Drive wheel
4 Brake assembly
30 Transmission
40 Adapter housing
41 Flange part
42 Cover part
43 Terminal box
44 Shaft
45 Tappet
46 Armature disk
47 Magnet body, e.g., coil core

1-13. (canceled)

14. A brake assembly, comprising:
a transmission including a housing part and an input shaft;
an adapter including an adapter housing connected to the housing part of the transmission, the adapter housing accommodating at least one bearing adapted to rotatably mount the input shaft of the transmission; and
a brake including a flange part and a cover part, the flange part connected to the adapter housing on a side of the adapter housing facing away from the transmission, the cover part connected to the flange part.

15. The brake assembly according to claim 14, wherein a first toothed part is rotationally fixed to the input shaft of the transmission and is in engagement with another toothed part of the transmission.

16. The brake assembly according to claim 14, wherein the cover part together with the flange part form a housing.

17. The brake assembly according to claim 15, wherein the cover part together with the flange part form at least part of a housing.

18. The brake assembly according to claim 14, wherein a tappet is rotationally fixed to the input shaft, a brake pad carrier is rotationally fixed to the tappet and is axially movable relative to a magnet body of the brake, the magnetic body of the brake is rotationally fixed to the flange part, an energizable coil is accommodated in the magnet body, an armature disk is arranged axially between the brake pad carrier and the magnet body, the armature disk is rotationally fixed to the magnet body and is arranged to be axially movable relative to the magnet body, and spring elements supported on the magnet body press onto the armature disk.

19. The brake assembly according to claim 18, wherein the brake pad carrier is movable back and forth relative to the magnet body of the brake.

20. The brake assembly according to claim 18, wherein the armature disk is movable back and forth.

21. The brake assembly according to claim 18, wherein the armature disk is rotationally fixed to the magnet body and is arranged to be axially movable relative to the magnet body by bolts projecting through cutouts in the armature disk and fixed to the magnet body.

22. The brake assembly according to claim 14, wherein the flange part includes a braking surface.

23. The brake assembly according to claim 14, wherein the flange part includes a finely machined braking surface.

24. The brake assembly according to claim 18, wherein the input shaft projects through the magnet body.

25. The brake assembly according to claim 24, wherein an angle sensor is connectable and/or arrangeable inside the cover part on an end region of the input shaft facing away from the adapter housing.

26. The brake assembly according to claim 25, wherein a sensor shaft of the angle sensor is rotationally fixed to the input shaft, and a housing of the angle sensor is connected to the magnet body and/or is connected to the cover part.

27. The brake assembly according to claim 14, wherein the brake is connected directly to the transmission via the adapter.

28. The brake assembly according to claim 27, wherein no motor or electric motor is interposed between the brake and the transmission.

29. The brake assembly according to claim 14, wherein a terminal box is attached to an outside of the cover part, supply lines of the brake being led out to the terminal box.

30. The brake assembly according to claim 14, wherein the supply lines of the brake are arranged as supply lines of a coil of the brake.

31. The brake assembly according to claim 14, wherein the adapter housing is formed of two parts, the bearing accommodated in the adapter housing is adapted to center, in relation to each other, the two parts of the adapter housing that form the adapter housing, one of the two parts connected to the flange part having a braking surface of the brake.

32. The brake assembly according to claim 14, wherein the adapter housing includes a cuboidal region.

33. A storage and retrieval device, comprising:
the brake assembly as recited in claim 14; and
a wheel arranged as a lateral guide rotationally fixed to an output shaft of the transmission.

34. The device according to claim 33, wherein the wheel is arranged as a guide wheel.

35. The device according to claim 33, wherein the wheel is arranged on a top side of a frame of the storage and retrieval device.

36. The device according to claim 33, wherein a drive wheel adapted to be driven by an electric drive is arranged on a bottom side of the frame of the storage and retrieval device.

37. The device according to claim 36, wherein the drive wheel is arranged as a rail wheel, and the storage and retrieval device is arranged as a rail vehicle.
